(19) United States
(12) Patent Application Publication
(10) Pub. No.: US 2004/0034546 A1
(43) Pub. Date: Feb. 19, 2004

(54) Method for registering tickets

(75) Inventors: Alfred Lauper, Zurich (CH); Rolf Bachtiger, Oberwil-Lieli (CH)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS TRANSIT TELEMATIC SYSTEMS AG, BRONSCHHOFEN (CH)

(21) Appl. No.: 10/643,901

(22) Filed: Aug. 20, 2003

Related U.S. Application Data
(63) Continuation of application No. PCT/EP02/00288, filed on Jan. 14, 2002.

(30) Foreign Application Priority Data
Feb. 21, 2001 (EP) 01104119.1

(51) Int. Cl. G06F 17/60

(52) U.S. Cl. 705/1

(57) ABSTRACT

Electronic tickets passing through a passage area and arriving in a detection area receive a first information unit including the identity of the detection area, whereby a second transmitter/receiver module located on the ticket is activated. At the beginning of the provision of a service, for instance, after the departure of a train, the tickets receive a second information unit that likewise includes the identity of the detection area, wherein at least the identity of the detection area is then stored as presence information if it matches the identity contained in the first information unit. If necessary, this method step is repeated. When the tickets leave the detection area through the passage area, they receive once again a first information unit and transmit a third information unit containing the stored presence information along with the identity of the ticket to a second transmitter/receiver unit, which registers the presence of the corresponding ticket.

The present application is a continuation of international patent application number PCT/EP02/00288, filed Jan. 14, 2002, and further claims priority to priority European application 01104119.1, filed Feb. 21, 2001, both of which are herein incorporated by reference.

### BACKGROUND OF THE INVENTION

The present invention relates to a system and method for registering persons partaking of a service. For purposes of illustration, the persons comprise passengers and the service comprises transportation. The registering takes place via a ticket. The present invention however may find other applications as envisioned by one skilled in the art.

A registering of passengers, who must place a ticket in or in front of a detection device when boarding a means of transport, considerably reduces throughput and results in unnecessarily and lengthy delays and stops. The disadvantage of such ‘check-in/check-out’ methods is overcome by so-called ‘walk-in/walk-out’ methods. This registration takes place either when boarding and/or disembarking or in some cases during the journey, without passengers having to perform any action with their tickets.

EP 1065625 A1 discloses a method for detecting objects by means of a transponder, wherein a first information unit is transferred to the transponder, preferably in the 127-kHz frequency range, when a detection zone is entered. On the basis of the information contained in the first information unit, a transmitter module on the transponder is activated immediately or following a delay, in order to transfer a second information unit at least once to a receiver unit which is located in the detection zone. It can thus be established that the object assigned to the transponder has spent time in this detection zone. The transmission of the second information unit preferably takes place in the range of several 100 MHz.

The international patent application PCT/EP00/08292 specifies a method and a system for registering tickets, wherein a first information unit is transferred to an electronic ticket, preferably in a frequency range of 13.5 MHz, when a detection zone is entered. Using an information item contained in this information unit, a receiver module located on the ticket is periodically switched to active, and a bi-directional communication is established by a transmitter/receiver unit assigned to the detection zone, and the current presence of the ticket is registered as a ticket record. The bi-directional communication is preferably established in the frequency range of 868 MHz.

The registration of electronic tickets should satisfy the following conditions:

a) The registration must be complete. For example, the tickets carried in a coat pocket for a father and each of the accompanying children must be detected.

b) No undesired registration should occur. For example, if a person with such an electronic ticket helps another person to board, this additional person must not be registered as a fare-paying passenger.

c) The registration must be as secure as possible against fraud. For example, the covering of the electronic ticket with a metallic foil should be recognized.

d) The power sources which are required on the ticket should allow maximum operational availability of the ticket.

The requirement d) results in an intermittent operating mode as specified in both of the aforementioned documents. Either the transmitter module on the ticket or the receiver module on the ticket is intermittently switched to active. The solution cited in EP 1065625 A1 has the disadvantage that even tickets which are no longer in the relevant detection zone transmit messages. This disadvantage does not apply to the solution specified in PCT/EP00/08292, where partially resource-intensive methods are required to avoid collisions or to terminate the communication successfully in further iterations.

### SUMMARY OF THE INVENTION

The present invention therefore addresses the problem of specifying a simpler method for registering electronic tickets, which method allows a secure and reliable detection of genuine passengers or service purchasers, and minimizes the danger of collisions in the communication.

As a result of the present inventive method, a minimum number of collisions are possible when a multiplicity of tickets enter a detection zone and during the electronic ‘stamping’ which takes place subsequently during method step B, since the transmitted information units are always broadcast messages. When leaving the detection zone through the passing zone, the throughput of people is significantly restricted and therefore the probability of collisions in the communication from the tickets to the receiver units is relatively low.

The present invention includes the following advantages:

i) By virtue of the fact that the first information unit (INF1) transferred in a method step A contains an information item (CYCLE1) which causes a second transmitter/receiver module (12) contained on the ticket to be intermittently switched to active, a significant reduction in power consumption is produced, which greatly increases the autonomy of a ticket.

ii) By virtue of the fact that the second transmitter/receiver module (12) is periodically switched to active with a cycle time (t_{CYCL}) contained in the first information unit (INF1), a fixed time shift of the cycles can significantly reduce collisions with other detection zones.

iii) By virtue of the fact that an information item (COMMAND2) is contained in the second information unit (INF2) received in method step B, which information item deactivates the second transmitter/receiver module (12) located on the ticket (10) after storage of the attendance information (INFA) has taken place, a further significant reduction in power consumption is produced, without a reduction in the detection rate or the detection resolution which is important for the user.

iv) By virtue of the fact that the frequency of the first transmitter unit (31) is selected such that the field in the passing zone (21) is designed as a near field, the tickets (10) can reliably be awaken from a sleep state while nonetheless preventing tickets (10) which are outside the passing zone from unnecessarily receiving a first information unit (INF1), and furthermore a good contact with the tickets through the human body, clothes and bags is guaranteed.

v) By virtue of the fact that the second information unit (INF2) is transmitted by the first transmitter unit (31) in the method step B, the equipment configuration is simplified, and moreover the tickets can return to a sleep state after receiving a second information unit (INF2), since the tickets can reliably be awaken by means of the near field in the detection zone.

vi) By virtue of the fact that the method step C is followed by a method step C1 in which, on the basis of a third information unit (INF3) received by the second transmitter/receiver unit (32), a second information unit (INF2) is transmitted in order to identify the attendance information (INFA) on the ticket (10) as debited, any as yet undebited attendance information can subsequently be transmitted to the second transmitter/receiver unit after the method step A in the context of a further journey, when the relevant ticket is used again, thereby ensuring that no negative consequences of an erroneous transmission can occur.

vii) By virtue of the fact that an information item (APPLICATION2) is contained in the second information unit (INF2) in the method step B, which information item can be displayed on a display module located on the ticket (10), the method according to the invention can also be used for passenger information without restricting the detection rate.

The invention is not limited to transport, but can also be applied to electronic admission or entrance tickets, e.g. to an exhibition. It is also possible to configure the invention as an identity card. Therefore the designation ‘ticket’, as used in this document, also includes the concept of ‘admission ticket’, ‘entrance ticket’ or ‘identity card’, as well as similar tickets and cards, in each case.

### BRIEF DESCRIPTION OF THE SEVERAL VIEWS OF THE DRAWINGS

The novel features believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a layout of a railway carriage with boarding and passageway areas, as well as an arrangement of transmitter/receiver units as well as associated zones,

FIG. 2 depicts layout of a bus with two boarding areas, as well as the arrangement of a transmitter/receiver unit and associated zones,

FIG. 3a depicts a sequence of communication with a ticket,

FIG. 3b depicts a detailed illustration of the sequence of the communication with a ticket in a further embodiment of the invention, and

FIG. 4 depicts a block schematic diagram of an electronic ticket for the method in accordance with the invention.

### DETAILED DESCRIPTION OF THE INVENTION

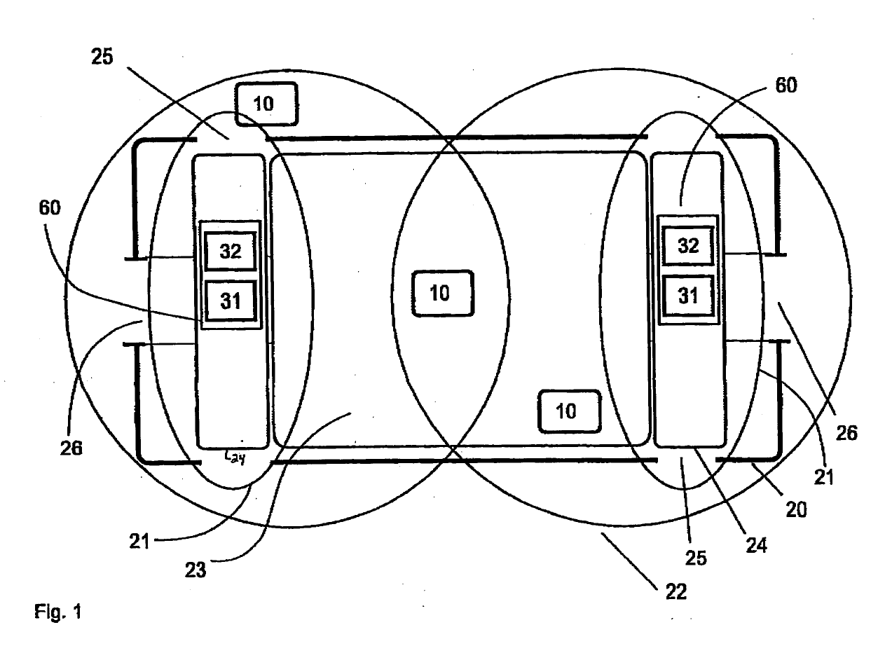

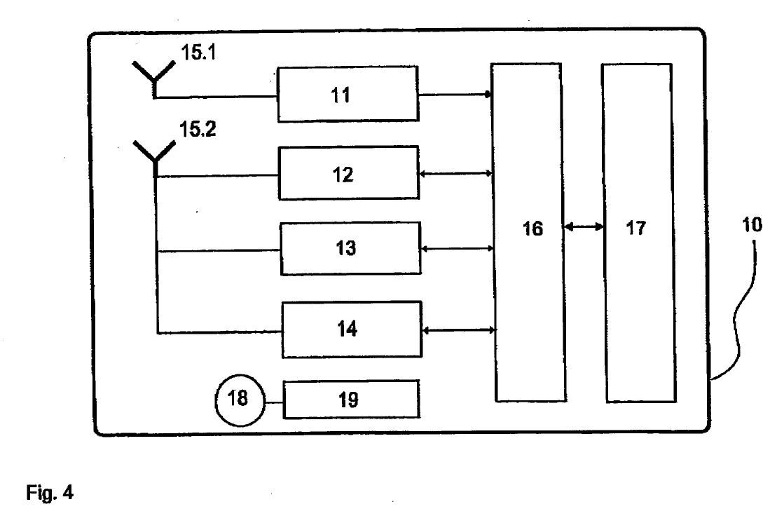

FIG. 1 illustrates the layout of a railway carriage 20 having four boarding areas 25 and having a passageway area 26 at each end of the carriage. The passageway area 26 facilitates passage to another train car. The two areas 25 and 26 may be accessed through platform 24 to the passenger compartment 23. For the sake of clarity, doors have not been shown. The platform 24 and the passenger compartment 23 may be configured to be open or to have a wall and an associated door. A first transmitter unit 31 and a second receiver unit 32 in a detection device 60 are assigned to each of the two platforms 24. In a further configuration of the invention, a second transmitter/receiver unit 32, which is also given the reference numeral 32, can be provided instead of the second receiver unit 32. In the following, reference will always be made to a second transmitter/receiver unit, though this can also signify only a receiver unit 32 depending on the method configuration. The transmitter unit 31 covers the relevant passing zone 21 with an electromagnetic field. A frequency of 6.78 MHz or 13.5 MHz or 27 MHz is preferably provided for this purpose. It is not obligatory in other applications for the passing zone 21 to correspond to the platform 24 as in the present example. The limit which is marked for the passing zone 21 corresponds approximately to the coverage in relation to minimum field strength of the relevant transmitter unit 31. The limit of the detection zone 22 corresponds approximately to the range of a second transmitter module 12 which is present on the ticket 10 (see FIG. 4), in relation to the receipt by the corresponding second transmitter/receiver unit 32. A frequency range of 868 MHz to 870 MHz is preferably provided for this purpose, wherein one frequency from this range is used for the so-called down-link, i.e. to the ticket 10, and another frequency from this range is used for the so-called up-link, i.e. from the ticket 10 to the second transmitter/receiver unit 32. An overlap of the two detection zones 22 corresponding to the paired arrangement of the transmitter/receiver units 32 for this railway carriage is necessary in order to be able to detect all passengers irrespective of their position in the railway carriage 20, Use of a frequency in the range 432-434 MHz is also suitable, depending on statutory regulations.

FIG. 4 depicts a block schematic diagram of an electronic ticket 10. Such tickets 10 preferably have a credit card format. In the block schematic diagram, a processor module 16 is provided as a central control unit, and connected to an associated storage module 17, a receiver module 11, a second 12, a third 13, and a fourth transmitter/receiver module 14. Depending on the selected frequencies, a single antenna or a plurality of antennas can be provided. Two antennas 15.1 and 15.2 are provided in the embodiment as per FIG. 4. The power supply takes place by means of a battery 19 and a power supply module 18; for the sake of clarity, the connections are not marked. In a further configuration, the ticket 10 can also feature a display module (not illustrated in FIG. 4). The embodiment of the method in accordance with the invention, as described below, is not restricted to the specified first receiver module 11 and the second transmitter/receiver module 12; the third and/or fourth transmitter/receiver modules 13 and/or 14 can also be provided, together with correspondingly selected transmission paths and frequencies; e.g. proximity cards.

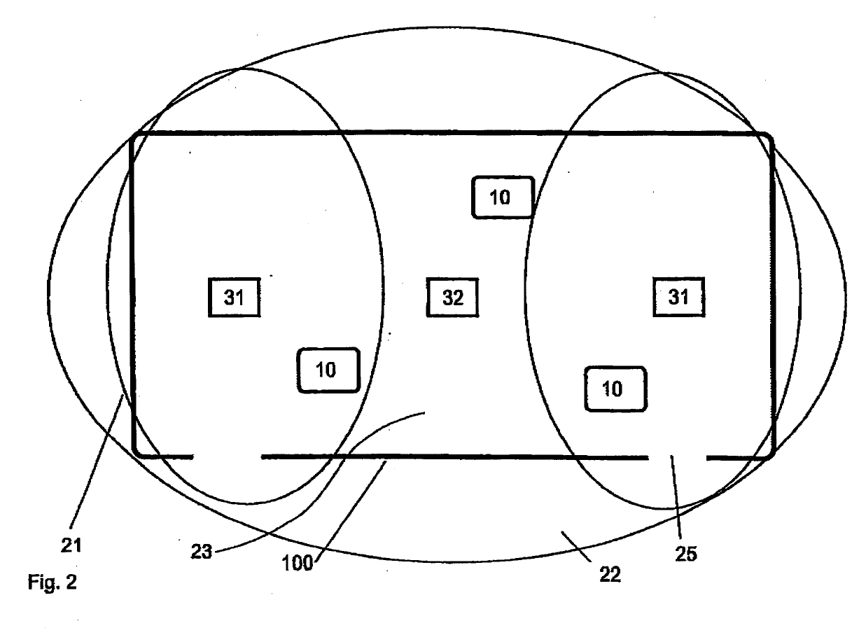

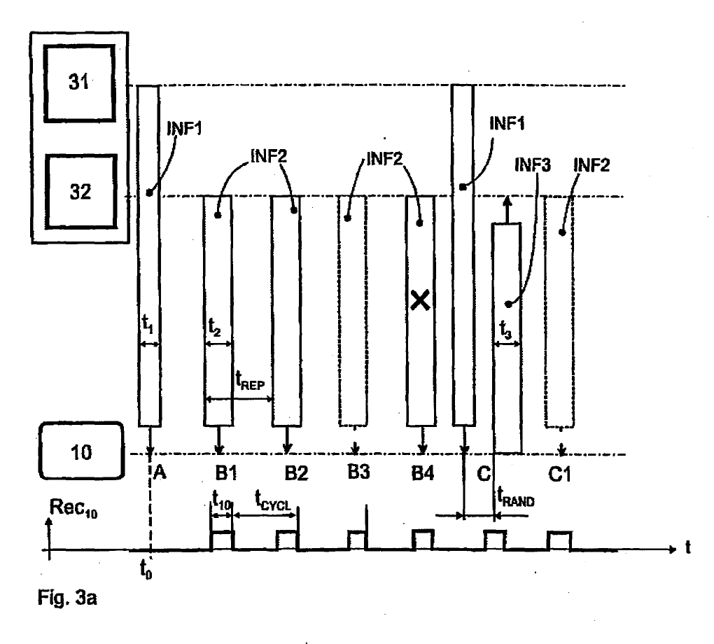

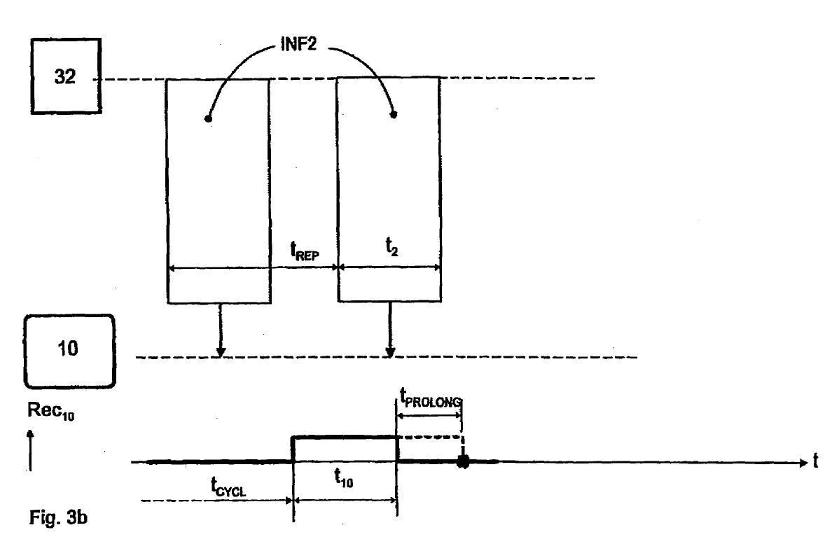

A first embodiment of the method according to the invention is now discussed with reference to FIG. 3a for a bus 100 (FIG. 2) or a railway carriage 20 (FIG. 1). It is required in this embodiment, for the railway train, that the individual units 31, 32 in the carriage be networked via a wire interface or radio interface. FIG. 3a depicts the information 3o flow over the radio section between an electronic ticket 10 and a detection unit 60 comprising a first transmitter unit 31 and a second transmitter/receiver unit 32 as described above. In order to simplify the explanations, a distinction is not made in each case between a method step, e.g. B2, and the instant at which this method step starts or the period in which this method step executes; where there is no ambiguity, the reference sign B2 will also be used for the instant or the approximate period.

Method Step A

Requirement:

The ticket 10 should be in a power-saving ‘sleep state’, i.e. only the first receiver module 11 is ready to receive.

Description of Method Step A:

If a person now approaches the boarding area 25 of the bus 100, this person carrying the ticket 10 enters the so-called passing zone 21. When the doors are open, the first transmitter unit 31 transmits an information unit periodically, i.e. in a 0.5-s cycle. This information unit is called INF1 and has a structure as per Table 1 below.

Information Unit INF1

TABLE 1

| Information field | Meaning |
|---|---|
| ADDRESS1 | Address of the transmitter unit 31 |
| CYCLE1 | Time unit, time reference; cycle time |
| COMMAND1 | Commands to the ticket 10 |
| POSITION1 | Location, boarding location |
| COURSE1 | Course number and/or carriage number |
| DATETIME1 | Date and time |
| TYPE1 | Type of transport |

These details are stored in the ticket 10 in an area of the storage module 17: INF1ₙ. If this information unit is received more than once, it will only result in an additional, separate storage of INFₙ₊₁ if the field COURSE1 has changed. This can occur if the person boards and then immediately disembarks from the vehicle (i.e. bus), and then boards another. This process also occurs in a railway station if a person carrying the ticket 10 in accordance with the invention walks past the respective entry zones 21 of different trains and the doors of the trains are open. If the details in the field COURSE1 remain the same, preferably only the fields CYCLE1 and COMMAND1 are updated. This process is not limited to one ticket 10, but occurs simultaneously for all the tickets 10 located in the entry zone 21, since the transmission of the information units INF is configured as a so-called broadcast message. In FIG. 3a, the instant t₀ is assigned to the receipt of the information unit INF1 on the ticket 10. The duration for complete transmission of the unit INF1 is t₁, e.g. t₁=30-80 ms per polarization. As a result of receiving information units INF1 containing the fields COMMAND1 and CYCLE1, a timer of the processor module 16 is initialized. This timer causes an intermittent activation of the second transmitter/receiver module 12 in accordance with a cycle time t_{CYCLE} contained in the field CYCLE1 (FIG. 3b). The time reference is also defined in the field CYCLE1. In FIG. 3a, the relevant switching state of the second transmitter/receiver module 12 on the ticket 10 is designated as Rec₁₀ (Rec: receive).

Method Step B1

Requirement:

A person carrying a ticket 10 boards the bus 100 as per method step A, but the bus 100 has not yet departed, Description of method step B1:

A second information unit INF2 is iteratively transmitted by the second transmitter/receiver unit 32 with the repetition time t_{REP} and received by a ticket 10. The information unit INF2 has a structure as per Table 2, for example.

Information Unit INF2

TABLE 2

| Information field | Meaning |
|---|---|
| ADDRESS2 | Received address of a transmitter/receiver unit 32 |
| CYCLE2 | Time unit, time reference, cycle time |
| COMMAND2 | Commands to the ticket 10 |
| POSITION2 | Location |
| COURSE2 | Course nunber |
| DATETIME2 | Date and time |
| TYPE2 | Type of transport |
| ADDRESS2 | Address of the transmitter/receiver unit 32 |
| DUTY2 | Specification of the service purchase |
| APPLICATION2 | Application |

When the information unit INF2 is received on the ticket 10, the timer of the processor module 16 is updated with the content of the field CYCLE2 if the field COMMAND contains e.g. the value SYNCH. If the field DUTY2 contains the value NO_CHARGE, this means that the ticket can ignore the remaining fields with the exception of CYCLE2 and COMMAND. If the relevant bus has to make a prolonged stop, this method step is iterated accordingly. Depending on the application and the vehicle type, t_{REP} can be in the range from 5 s to 600 s, for example. The duration of the transfer of the information unit INF2 is preferably selected to be approximately the same as the ON-time t₁₀ and is approximately t₂=5-10 ms.

Method Step B2

Requirement:

A person carrying a ticket 10 is on a bus 100 which has departed. The ticket 10 is in a state as per the history of the method steps A and if applicable B1.

Description of method step E2:

At the instant B2, the ticket 10 receives an information unit INF2 which has been transmitted by the second transmitter/receiver unit 32. The value CHARGE is contained in the field DUTY2, as a result of which an entry is made in the storage module 17 on the ticket 10 under the following condition:

If the details in the field COURSE2 match a value COURSE1 from INFₙ, INFₙ₊₁, etc., as stored on the ticket 10 in the method step A, the aforementioned entry from the method step A is assigned a code and stored as the 1st entry of a so-called attendance information INFA in the storage module, together with the details received in this method step B2. An example of the structure of this attendance information INFA is shown below in Table 3.

Attendance Information INFA

TABLE 3

| Informaton field | Meaning |
|---|---|
| ADDRESS1 | Received address of a transmitter unit 31 |
| ADDRESS2 | Received address of a transmitter unit 32 |
| COURSE1 | Course number |
| POSITION1 | First marked location, based on the receipt |
| | of the information unit INF1 |
| DATETIME1 | Date and time, based on the receipt of the |
| | information unit INF1 |
| POSITION2 | Marked location, based on the last receipt |
| | of the information unit INF2 |
| DATETIME2 | Date and time, based on the last receipt of |
| | the information unit INF2 |
| : | |

Depending on the application, a further field DUTY can be entered with the fields POSITION/DATETIME in the attendance information INFA for ‘stamping’, so that the type of service purchase is also included for the details stored in POSITION/DATETIME. The attendance information can therefore contain an iteration of the aforementioned fields, e.g.

POSITION1
DATETIME1
DUTY1
POSIT I0N2
etc.

In a particularly advantageous embodiment of the invention, the field APPLICATION2 of the second information unit INF2 can contain the next stop of the transport vehicle concerned and the field COMMAND2 can contain an entry DISPLAY. The content of the field APPLICATION2 is then supplied by the processor module 16 to a display module on the ticket 10 and provides important information for the user. The method step B2 is preferably iterated in the case of short-distance transport. This is not just required because of the aforementioned stop information, but also for reasons of reliability and comprehensive ‘stamping’ of the tickets in the individual journey sections.

Method Step B3

Requirement:

As a result of the method steps A, B2 and if applicable B1, at least one pair of entries from two information units INF1 and INF2 are present on the ticket 10 as shown in Table 4.

Description of Method Step B3:

On the basis of the cycle time agreed in the fields CYCLE1 or CYCLE2, receipt of a second information unit INF2 likewise takes place in this method step B3, as in the method step B2; to make it easier for the user to understand, this process can be considered as a periodic ‘stamping’ of a ticket. Depending on the requirement of a transport company or of a fare management operator for a plurality of transport companies, various advantageous configurations of the present invention can be implemented in this method step.

In a further configuration, as already anticipated in Table 3, the penultimate entry POSITION2 and DATETIME2 can be overwritten on the ticket 10 with a value which has just been received from the information unit INF2. A significant amount of storage on the ticket can thus be advantageously saved, If it is always necessary, in relation to a passenger or service purchaser, to perform a verification which is continuous in the present as per the time t_{REP}, the entries POSITION2 and DATETIME2 are preferably stored successively. Further entries can also be stored, for example from the field DUTY, in which values of the type CHARGE1, CHARGE2 are provided, which allow different tariffs to be applied during a journey.

In a further embodiment, provision can be made for including a field CYCLE2 (cf. Table 2) in the second information unit INF2, the field being used to switch the second transmitter/receiver module 32 on the ticket 10 to active in relation to receive readiness in a changed cycle t_{CYCL}. This is particularly advantageous if a train initially serves a close succession of stations, and then travels to a far distant town as an intercity train. The autonomy of the tickets 10 is further improved as a result, since the ‘stamping’ as per method step B is no longer required as frequently in this case.

Alternatively or additionally to the aforementioned resetting of the cycle time t_{CYCL}, and independent of the configuration with the successive overwriting of the last entry for POSITION2 and DATETIME2, provision can be made for saving power by entering the value ASLEEP in the field COMMAND2, as a result of which the relevant ticket 10 returns to the original sleep state after the receipt of a second information unit INF2.

Method Step B4

Requirement:

The ticket 10 is in a state as per the history of the method steps A and B2, and if applicable B1.

Description of the Method Step B4;

The method step B4 describes an error event where, due to difficult receiving conditions, a second information unit INF2 could not be received by the ticket 10. The first information unit INF1, received in the method step Ar preferably still contains a value in the field CYCLE1, which value specifies how often the receiver module 12 on the ticket 10 is switched to active: If a second information unit INF2 is not received during this specified number, the ticket 10 returns to a sleep state. The following explanation of method step C shows that the method according to the invention also overcomes such an error event, when no second information unit whatsoever is received, but with the limitation that it is not possible to produce verification of the actual stay of the user in the detection zone 22.

Method Step C

Requirement:

The ticket 10 is in a state as per the history of the method steps A, and if applicable B1 and B2.

Description of the Method Step C:

A person with a ticket 10 leaves the detection zone 22 through the passing zone 21. In order to leave the aforementioned zone 22 in the prescribed manner, the doors of the bus must be opened. This causes the first transmitter unit 31 to be activated and the ticket 10 receives a first information unit INF1 having the structure as specified in Table 1. Irrespective of the state of the ticket 10, e.g. sleep mode, the processor module 16 recognizes that the identity of the detection zone 22 has remained the same. As usual, where the receipt of second information units INF2 has caused an attendance information INFA as per the details in Table 3 to be entered in the storage module 17, a third information unit INF3 is transferred from the second transmitter/receiver module on the ticket 10 to the second transmitter/receiver unit 32. The structure of this third information unit INF3 is shown in Table 4 below.

Information Unit INF3

TABLE 4

| Information field | Meaning |
|---|---|
| ADDRESS3 | Received address of a transmitter/receiver unit 32 |
| COURSE3 | Course nunber |
| POSITION1 | First marked location |
| DATETIME1 | Time stamp for the field POSITION1 |
| DUTY1 | Type of service purchase for POSITION1 |
| POSITION2 | Second marked location |
| DATETIME2 | Time stamp for the field POSITION1 |
| DUTY2 | Type of service purchase for POSITION2 |
| : | |
| TYPE3 | Type of ticket |
| TICKET_ID3 | Ticket identity |
| : | |
| ATTRIBUTES3 | Attributes |
| STATE3 | State information |

The transmitter/receiver unit 32 only processes those information units INF3 that match, at least in terms of the details in the field COURSE3 and/or ADDRESS3. Where there is such a match, the details contained in the third information unit INF3 are stored as ticket records TICK_REC, for example in the second transmitter/receiver unit 32 or in an on-board computer assigned to said unit. A ticket record TICK_REC has a structure as per Table 5, for example, where REC means ‘record’.

Ticket Record TICK_REC

TABLE 5

| Information field | Meaning |
|---|---|
| TYPE | Type of ticket |
| TICKET_ID | Ticket identity |
| : | |
| ATTRIBUTES | Attributes |
| : | |
| POSITION1 | First marked location, based on the |
| | receipt of the information unit INF1 |
| DATETIME1 | Date and time, based on the receipt of |
| | the information unit INF1 |
| DUTY1 | Type of service purchase for POSITION1 |
| POSITION2 | Marked location, based on the last |
| | receipt of the information unit INF2 |
| DATETIME2 | Date and time, based on the last receipt |
| | of the information unit INF2 |
| DUTY2 | Type of service purchase for POSITION2 |
| : | |
| POSITION_TRANSFER | Location at instant of receipt of INF3 |
| DATETIME_TRANSFER | Instant of receipt of INF3 |
| STATE | State information |
| : | |

The filing of such ticket records TICK_REC substantiates the attendance of a ticket 10 having the identity TICKET_ID by specifying a sequence of respective location, respective date and time and, if applicable, respective type of service purchase. The specification of location in a control system of the relevant bus 100 is known, e.g. by means of GPS receivers or another system for localization of public transport. Collisions are possible in the method step C, as shown in the following calculation: the throughput of people disembarking through a door of a public transport vehicle under ideal conditions is approximately 10 people as a maximum. The transmission of a third information unit requires as a maximum is t₃=10 ms in the frequency range specified at the beginning. A random number generator, which is contained on the ticket 10 and whose output values depend on the identity stored on the ticket, is used to transmit the third information unit INF3 at a period which is delayed by t_{RAND} after receipt of the first information unit INF1, cf. approximate illustration in FIG. 3a. Provision is preferably made for the tickets 10 to transmit the third information unit INF3 several times at randomly selected intervals, wherein the overall duration is not grater than approximately 4 s. In this way, collisions can be reduced to a minimum; and non-detection is improbable. It should also be noted that the throughput when disembarking is approximately 5 to 8 people per second.

Method Step C1

Requirement:

A ticket 10 is in a state as per the history of the method step C.

Description of the Method Step C1:

In an advantageous development of the present invention, the method step C can be followed by a method step C1, which on the one hand reduces the danger of collisions of the type described above, and excludes the aforementioned non-detection due to collisions. For this purpose, provision is made for the transmitter/receiver unit to transmit a second information unit INF2 following the receipt of a third information unit INF3, said second information unit INF2 containing the identity of the relevant ticket 10 in a field TICKET_ID2 which is not shown in Table 2, and containing the value ACK (acknowledge, confirmation), for example, in the field COMMAND. The effect of the receipt of this second information unit INF2 on the relevant ticket 10 is to prevent the further transmission of a third information unit INF3. The other tickets 10 also receive this second information unit INF2, but since the identity of the ticket 10 contained therein does not match, the receipt of such an information unit INF2 is ignored. With the receipt of such a second information unit, the attendance information INFA stored on the ticket 10 is identified as debited. If the rare event occurs that such a debiting does not happen—it is unimportant in this case whether the third information unit INF3 was not received or the acknowledgment as per method step C1 did not happen—the method in accordance with the invention has the advantage that the purchased journey or service can nevertheless still be detected: on the next journey, the ticket 10 is awoken from the sleep state as per method step A. At this point, the processor establishes that as yet undebited attendance information is present on the ticket 10. In a method step A1, the processor module 16 then initiates the transmission of a third information unit INF3 as per the previously described method step C and if necessary a method step C1.

FIG. 3b shows a variant of an embodiment of the present method according to the invention, for the case in which the detection devices 60 located in the carriages 20 of a railway train are not synchronized from carriage to carriage and/or do not have access to the same information relating to current cycle time or position or current course, cf. fields CYCLE, POSITION or COURSE in the first and second information unit. So that a ticket 10 can actually receive a second information unit when moving from one carriage 20 to another carriage 20, the repetition time t_{REP} is selected such that, together with the duration t₂ for the transfer of a second information unit INF2, an overlap ensures that said second information unit INF2 can also be received by the ticket 10 during the active switching of the receiver module 12. Independent of this case, FIG. 3b shows that the receive readiness of the receiver module 12 is extended by the processor module 16 if the information unit INF2 has not yet been fully transferred when the receiver module 12 is due to be deactivated. This is illustrated in FIG. 3b with the period t_{PROLONG}.

The ticket records TICK_REC are stored by the vehicle and supplied via radio or bulk storage to a computer system, which combines the multiplicity of such records for individually related journeys and uses the records to generate an invoice for the attention of a customer or to implement a debit from a credit account (CREDIT method or DEBIT method). Post processing with validation checking makes is possible to reconstruct any missing intermediate stamps TICKET_ID/POSITION/DATETIME/etc. It likewise allows any double detections which occur due to the overlap of the detection zones 22 to be recognized and eliminated.

The arrangement of the transmitter unit 31 and the transmitter/receiver unit 32 is not restricted to that shown in FIGS. 1 and 2, but can be adapted to the application concerned. In addition to the aforementioned integration of the transmitter unit 31 and the transmitter/receiver unit 32 in a detection device 60, provision can be made for arranging such detection devices 60 at a plurality of locations along a carriage, preferably on or above the interior ceiling, and either equip only some of them as required, or use a configuration parameter to predetermine the desired operating method as per the aforementioned method steps A, B and C. In particular, the multiple arrangement of such detection devices 60 is required if the transfer as per method step B takes place in a frequency range such that the field is designed as a near field in a subsection of the detection zone 22. This is preferably the same frequency range as in method step A.

The method in accordance with the invention can be performed using detection devices at the entrance, where the detection devices are designed as read/write devices and, on the basis of the electrical properties, the user brings the ticket 10 into proximity, e.g. to a distance of 10-20 cm, so that the method step A and/or C can be carried out. This allows many different ways of using the method in accordance with the invention.

The method in accordance with the invention can also be used for the purchase and charging of comparable services, e.g. as an entry ticket to a cinema or an exhibition. There are often various additional chargeable sections in an exhibition. The method in accordance with the invention can be used to ensure that a visitor is only allowed to visit such a specific section once without making a supplementary payment.

The invention can likewise be used for the monitoring and surveillance of people in specific zones. This could be required on sites where it may be necessary to anticipate accidents, and where the invention can be used to establish the last registered location of a person or the electronic identity card (=ticket) they were allocated, so that rescue personnel can search and intervene effectively. The invention can also be used to record a movement profile of a person in a highly sensitive area having different zones, e.g. also for the monitoring of a person in so-called semi-captivity. By arranging first transmitter units 31 at specific locations in an area, a method step A or C is generated in accordance with the invention. The third information unit INF3, which is transferred in method step C, can be used by the second transmitter/receiver unit 32 in order to open specific gates automatically or after a password has been entered.

The method in accordance with the invention can also be used to monitor objects on a conveying route, for which purpose an electronic ticket is attached to the relevant object, preferably in a secure manner.

The invention can also be used for the generation and analysis of statistical data, e.g. the occupancy of a train, without this method also resulting in any chargeable accounting.

We claim:

1. A method for registering a ticket when said ticket is proximate to a detection zone, said ticket comprising a processor module, a storage module, and at least one first receiver module and at least one second transmitter/receiver module, and said detection zone comprising a first transmitter unit and a second transmitter/receiver unit for communicating with said ticket, and at least one passing zone facilitating ingress and egress into said detection zone, said method comprising the steps of:
transmitting from said first transmitter unit to said first receiver module a first information unit when said ticket enters said detection zone, said first information unit comprising an identity assigned to said detection zone;
storing said identity on said ticket;
determining a timepoint based upon a predefined attendance or service, said timepoint being at a time subsequent to said steps of transmitting and storing;
receiving at said timepoint and ticket a second information unit, said second information unit comprising said identity, determining if said first information unit matches said second information unit;
upon a match, storing said second information unit on said ticket, said second information unit being indicative of attendance;
transmitting to tickets egressing said detection zone another first information unit; and
transmitting a third information unit from said second transmitter/receiver module to said second transmitter/receiver unit and storing said third information unit on said ticket, said third information unit being based upon said attendance information and identity of said ticket.

2. The method according to claim 1, wherein said first information unit transmitted from said first transmitter unit to said first receiver module comprises an information item by means of which said second transmitter/receiver module is intermittently switched to active in relation to receiving information units.

3. The method according to claim 2, further comprising the step of periodically switching said second transmitter/receiver module to active using an information item included as a cycle time in said first information unit.

4. The method according to claim 1, wherein said second information unit received at said timepoint comprises an information item which deactivates said second transmitter/receiver module located on the ticket following storage of attendance information.

5. The method according to claim 1, further comprising the step of transmitting said second information unit by said second transmitter/receiver unit.

6. The method according to claim 1, wherein said frequency of said first transmitter unit is selected such that said field in said passing zone is designed as a near field.

7. The method according to claim 1, wherein said frequency of said transmitter module is selected such that said field in said detection zone is designed as a far field.

8. The method according to claim 6, further comprising the step of transmitting said second information unit by said first transmitter unit.

9. The method according to claim 7, further comprising the step of transmitting said second information unit by said first transmitter unit.

10. The method according to claim 1, wherein said step of transmitting a third information unit further comprises the step of transmitting said third information unit after a randomly determined period following receipt of said first information unit.

11. The method according to claim 10, wherein said third information unit is transmitted more than once.

12. The method according to claim 1, further comprising, after said step of transmitting said a third information unit, the step of transmitting a second information unit, in order to identify said attendance information as debited on said ticket, and on the basis of a third information unit received by said second transmitter/receiver unit.

13. The method as according to claim 1, wherein said ticket comprises a display module and said second information unit comprises an information item which can be displayed on said display module.

14. The method according to claims 1, further comprising the step of periodically switching said second transmitter/receiver module to active using an information item included as a cycle time in said second information unit.
